(19) United States
(12) Patent Application Publication
(10) Pub. No.: US 2008/0089413 A1
(43) Pub. Date: Apr. 17, 2008

(54) Moving Image Encoding Apparatus And Moving Image Encoding Method

(75) Inventors: Hiroki Kishi, Chiba-ken (JP); Hiroshi Kajiwara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO JAPAN (JP)

(21) Appl. No.: 11/571,187

(22) PCT Filed: Jun. 23, 2005
(86) PCT No.: PCT/JP05/12008

§ 371 Date: Dec. 22, 2006

(30) Foreign Application Priority Data
Jun. 28, 2004 (JP) 2004-190405

(51) Int. Cl. H04N 7/50; H04N 7/32

(52) U.S. Cl. 375/240.13; 375/240.12; 375/E07.243

(57) ABSTRACT

An encoding unit that encodes a moving image using inter-frame motion prediction segments each frame into a plurality of segmented regions (302), and determines a region of interest from a frame to be decoded (317). The encoding unit (310) retrieves a pixel set, from the region of interest of the previous or succeeding frame, having high correlation to each segmented region of the frame to be encoded, calculates the difference between the data of each segmented region and data of the retrieved pixel set, and outputs difference data (314). Then, the encoding unit encodes the difference data (303, 306).

### CLAIM OF PRIORITY

This application claims priority from Japanese Patent Application No. 2004-190305 filed on Jun. 28, 2004, which is hereby incorporated herein by reference herein.

### TECHNICAL FIELD

The present invention relates to a moving image encoding apparatus and method and, more particularly, to a moving image encoding apparatus and method, which encode a moving image using motion prediction.

### BACKGROUND ART

In recent years, the contents which flow via a network are developing in the direction of large-capacity and diversification features, i.e., from text information to still image information and also to moving image information. An encoding technique that compresses an information size has been developed, and the developed encoding technique has prevailed by international standardization.

On the other hand, networks themselves are also developing in the direction of large-capacity and diversification features, and one content passes through various environments from the transmitting side to the receiving side. Also, the processing performance of the transmitting/receiving side devices is diversified. PCs mainly used as transmitting/receiving side devices have great performance gains of CPU performance, graphics performance, and the like, while various devices with different processing performances such as a PDA, portable phone, TV, hard disk recorder, and the like have a network connection function. For this reason, a function called scalability in which single data can cope with a changing communication line capacity and the processing performance of a receiving side device has received a lot of attention.

As a still image encoding method having this scalability function, a JPEG2000 coding scheme is well known. This scheme is internationally standardized, and its details are described in ISO/IEC15444-1 (Information technology—JPEG2000 image coding system—Part 1: Core coding system). JPEG2000 is characterized by using the discrete wavelet transform (DWT) to divide input image data by a plurality of frequency bands. The coefficients of the divided data are quantized, and the quantized values undergo arithmetic encoding for respective bitplanes. By encoding or decoding a required number of bitplanes, detailed hierarchy control is realized.

In the JPEG2000 coding scheme, a technique called ROI (Region Of Interest) which relatively improves the image quality of a region of interest in an image, and is not available in the conventional encoding techniques is realized.

FIG. 23 shows an encoding unit based on the JPEG2000 coding scheme. A tile segmentation unit 9001 segments an input image into a plurality of regions (tiles). This function is an option. A DWT unit 9002 divides respective tiles by frequency bands using the discrete wavelet transform. A quantizer 9003 quantizes respective coefficients. An ROI designation unit 9007 can set a region, such as an important region and a region of interest, to be coded with a higher quality than the other regions. At this time, the quantizer 9003 performs a shift-up process. An entropy encoder 9004 performs entropy encoding by an EBCOT scheme (Embedded Block Coding with Optimized Truncation). The lower bits of the encoded data are discarded by a bit truncating unit 9005 as needed for rate control. A code forming unit 9006 appends header information to the encoded data, selects various scalability functions, and outputs the encoded data.

FIG. 24 shows a decoding unit based on the JPEG2000 coding scheme. A code analysis unit 9020 analyzes a header to obtain information required to form a hierarchy. A bit truncating unit 9021 discards the lower bits of input encoded data in correspondence with an internal buffer size and decoding processing performance. An entropy decoder 9022 decodes the encoded data based on the EBCOT coding scheme to obtain quantized wavelet transformation coefficients. An inverse quantizer 9023 inversely quantizes the quantized wavelet transformation coefficients. An inverse DWT unit 9024 performs the inverse discrete wavelet transform to reclaim image data from the wavelet transformation coefficients. A tile composition unit 9025 composites a plurality of tiles to reconstruct image data.

Also, a Motion JPEG2000 scheme that encodes a moving image by applying the JPEG2000 coding scheme to respective frames of the moving image has been recommended (for example, see ISO/IEC15444-3 (Information technology—JPEG2000 image coding system Part 3: Motion JPEG2000)). In this scheme, encoding processes are independently done for respective frames. Since encoding using time correlation is not performed, redundancy remains between adjacent frames. For this reason, it is difficult to effectively reduce the code size compared to a moving image coding scheme using time correlation.

On the other hand, an MPEG coding scheme performs motion compensation to improve coding efficiency (see, e.g., “Latest MPEG Text”, p. 76, etc., ASCII Publishing Division, 1994). FIG. 25 shows the arrangement of that encoding unit. A block segmentation unit 9031 divides data into blocks of 8×8 pixels, a difference unit 9032 obtains the differences between the data of the respective blocks and predicted data obtained by motion compensation. A DCT unit 9033 performs discrete cosine transformation, and a quantizer 9034 performs quantization. The quantization result is encoded by an entropy encoder 9035. A code forming unit 9036 appends header information to the encoded data, and outputs the encoded data.

On the other hand, an inverse quantizer 9037 performs inverse quantization in parallel with the process of the entropy encoder 9035, an inverse DCT unit 9038 applies inverse transformation of the discrete cosine transformation, and an adder 9039 adds predicted data and stores the sum data in a frame memory 9040. A motion compensation unit 9041 calculates motion vectors with reference to an input image and reference frames stored in the frame memory 9040, thus generating predicted data.

For the purpose of improving the efficiency of the JPEG2000 coding, a compression scheme obtained by adding motion compensation to JPEG2000 is available. However, in such moving image compression scheme, when reference data for prediction (to be referred to as “reference data” hereinafter) is partially discarded by, e.g., truncation of the lower bitplanes, predictive errors accumulate, thus considerably deteriorating the inter-frame image quality. FIG. 26 shows a concept of reference data between inter-frame images.

### DISCLOSURE OF INVENTION

The present invention has been made in consideration of the above situation, and has as its object to suppress inter-frame image quality deterioration upon encoding a moving image using motion prediction.

According to the present invention, the foregoing object is attained by providing a moving image encoding apparatus for encoding a moving image using inter-frame motion prediction, comprising: a segmentation unit that segments each frame into a plurality of segmented regions; a determination unit that determines a region of interest from a frame to be encoded; an inter-frame prediction unit that retrieves a pixel set, from the region of interest of a previous or succeeding frame, having high correlation to each segmented region of a frame to be encoded, calculates a difference between the data of each segmented region and data of the retrieved pixel set, and outputs difference data; and an encoding unit that encodes the difference data.

According to the present invention, the foregoing object is also attained by providing a moving image encoding apparatus for encoding a moving image using inter-frame motion prediction, comprising: a segmentation unit that segments each frame into a plurality of segmented regions; a determination unit that determines a region of interest from a frame to be encoded; a transformation unit that performs data transformation for each segmented region to generate transformation coefficients; an inter-frame prediction unit that retrieves transformation coefficients, from transformation coefficients corresponding to the region of interest of a previous or succeeding frame, having high correlation to transformation coefficients of each segmented region of a frame to be encoded, calculates a difference between the transformation coefficients of each segmented region and the retrieved transformation coefficients, and outputs difference data; and an encoding unit that encodes the difference data.

Further, the foregoing object is also attained by providing a moving image encoding method for encoding a moving image using inter-frame motion prediction, comprising: segmenting each frame into a plurality of segmented regions; determining a region of interest from a frame to be encoded; retrieving a pixel set, from the region of interest of a previous or succeeding frame, having high correlation to each segmented region of a frame to be encoded, calculating a difference between the data of each segmented region and data of the retrieved pixel set, and outputting difference data; and encoding the difference data.

Furthermore, the foregoing object is also attained by providing a moving image encoding method for encoding a moving image using inter-frame motion prediction, comprising: segmenting each frame into a plurality of segmented regions; determining a region of interest from a frame to be encoded; performing data transformation for each segmented region to generate transformation coefficients; retrieving transformation coefficients, from transformation coefficients corresponding to the region of interest of a previous or succeeding frame, having high correlation to transformation coefficients of each segmented region of a frame to be encoded, calculating a difference between the transformation coefficients of each segmented region and the retrieved transformation coefficients, and outputting difference data; and encoding the difference data.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a view showing the concept of a moving image to be encoded in an embodiment of the present invention;

FIG. 2 is a block diagram showing the arrangement of a moving image processing apparatus according to the embodiment of the present invention;

FIG. 3 is a block diagram showing the arrangement of an encoding unit according to a first embodiment of the present invention;

FIG. 4 is a flowchart showing the encoding process according to the first embodiment of the present invention;

FIG. 5 is an explanatory view of tile segmentation;

FIG. 6 is a view showing an example of ROI tiles;

FIG. 7 is an explanatory view of linear discrete wavelet transform;

FIG. 8A is a view for decomposing data into four subbands, FIG. 8B is a view for further decomposing an LL subband in FIG. 8A into four subbands, and FIG. 8C is a view for further decomposing an LL subband in FIG. 8B into four subbands;

FIG. 9 is an explanatory view of quantization steps;

FIG. 10 is an explanatory view of code block segmentation;

FIG. 11 is an explanatory view of bitplane segmentation;

FIG. 12 is an explanatory view of coding passes;

FIG. 13 is an explanatory view of layer generation;

FIG. 14 is an explanatory view of layer generation;

FIG. 15 is an explanatory view of the format of encoded tile data;

FIG. 16 is an explanatory view of the format of encoded frame data;

FIG. 17 is a view showing the concept of reference data for MC prediction according to the first embodiment of the present invention;

FIG. 18 is a view showing the concept of reference data for MC prediction according to a second embodiment of the present invention;

FIG. 19 is a block diagram showing the arrangement of an encoding unit according to a third embodiment of the present invention;

FIG. 20 is a flowchart showing the encoding process according to the third embodiment of the present invention;

FIG. 21A shows an ROI and non-ROI in respective subbands, and FIGS. 21B and 21C show changes in quantized coefficient values by shift up;

FIG. 22 is a view showing the concept of reference data for MC prediction in the third embodiment of the present invention;

FIG. 23 is a block diagram showing an encoding unit based on the JPEG2000 coding scheme;

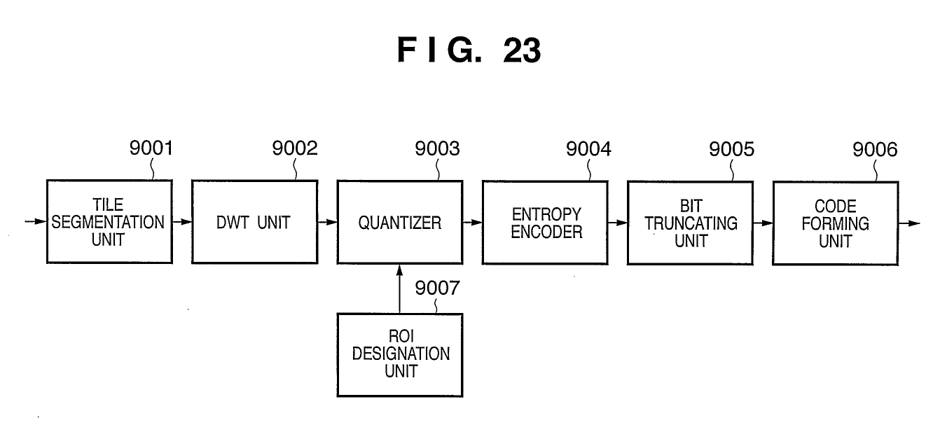

FIG. 24 is a block diagram showing a decoding unit based on the JPEG2000 coding scheme;

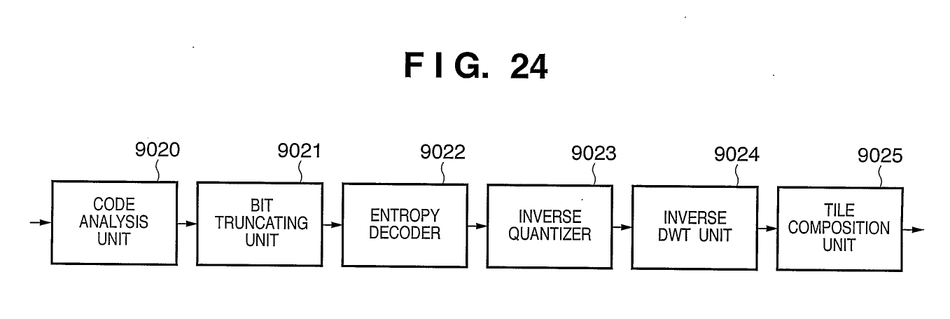

FIG. 25 is a block diagram showing an encoding unit based on the MPEG coding scheme; and

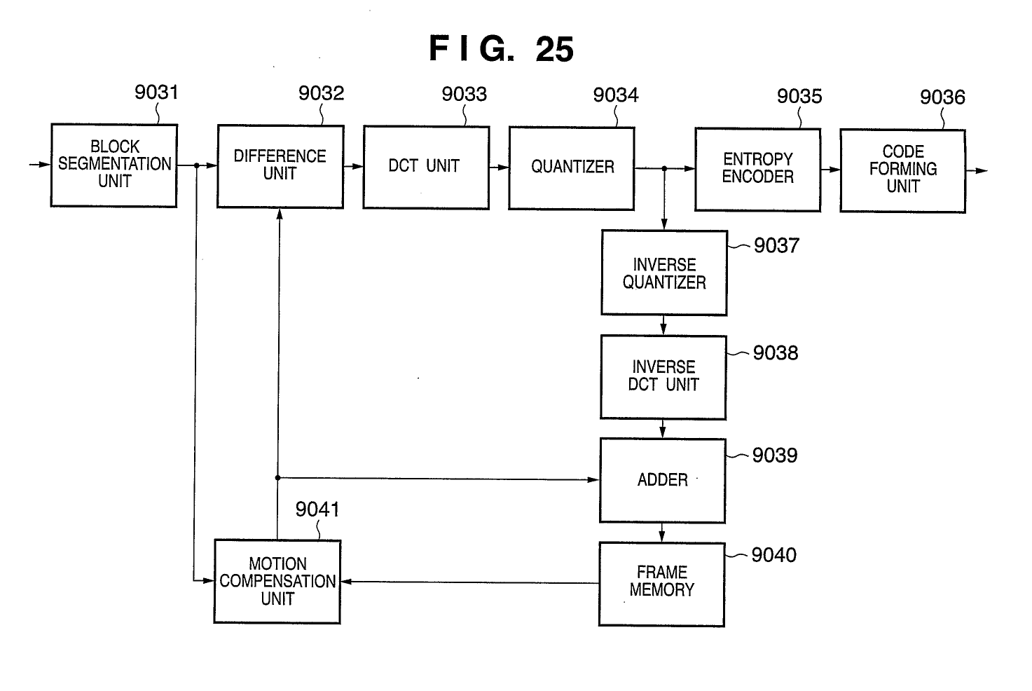

FIG. 26 is a view showing the concept of conventional reference data for MC prediction.

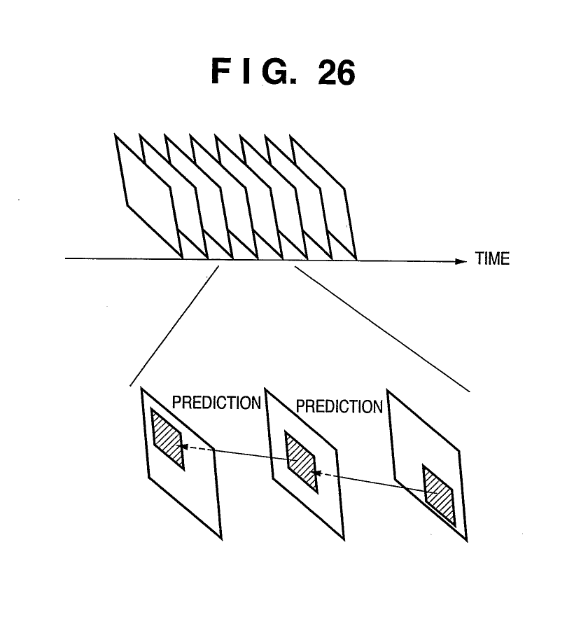

### BEST MODE FOR CARRYING OUT THE INVENTION

Preferred embodiments of the present invention will be described in detail in accordance with the accompanying drawings.

### FIRST EMBODIMENT

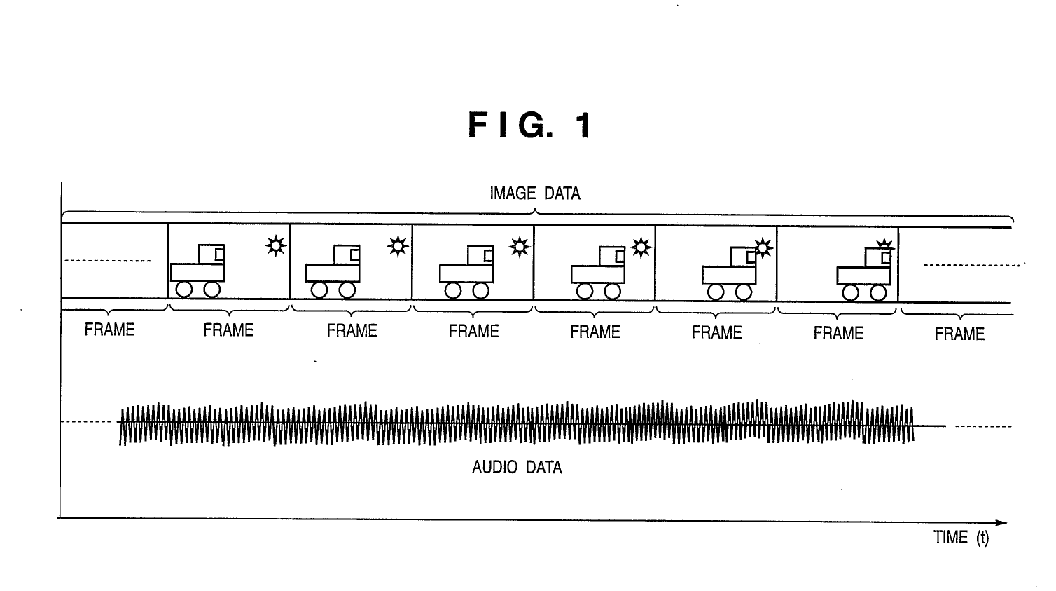

As shown in FIG. 1, moving image data to be processed in the present invention is formed of image data and audio data, and the image data is formed of frames indicating information at consecutive moments.

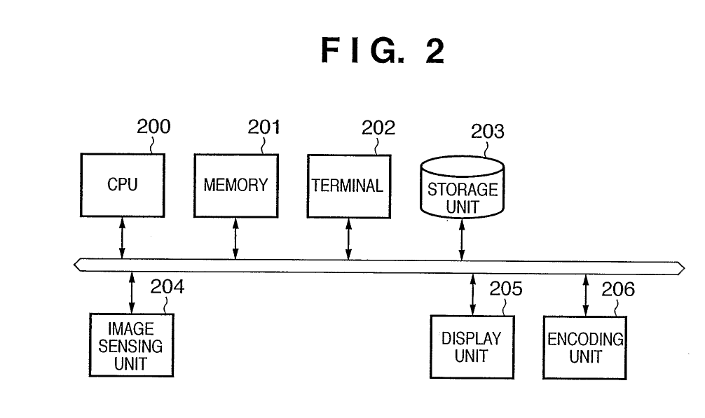

FIG. 2 is a block diagram showing the arrangement of a moving image processing apparatus according to the first embodiment. Referring to FIG. 2, reference numeral 200 denotes a CPU; 201, a memory; 202, a terminal; 203, a storage unit; 204, an image sensing unit; 205, a display unit; and 206, an encoding unit.

### <Processing of Encoding Unit 206>

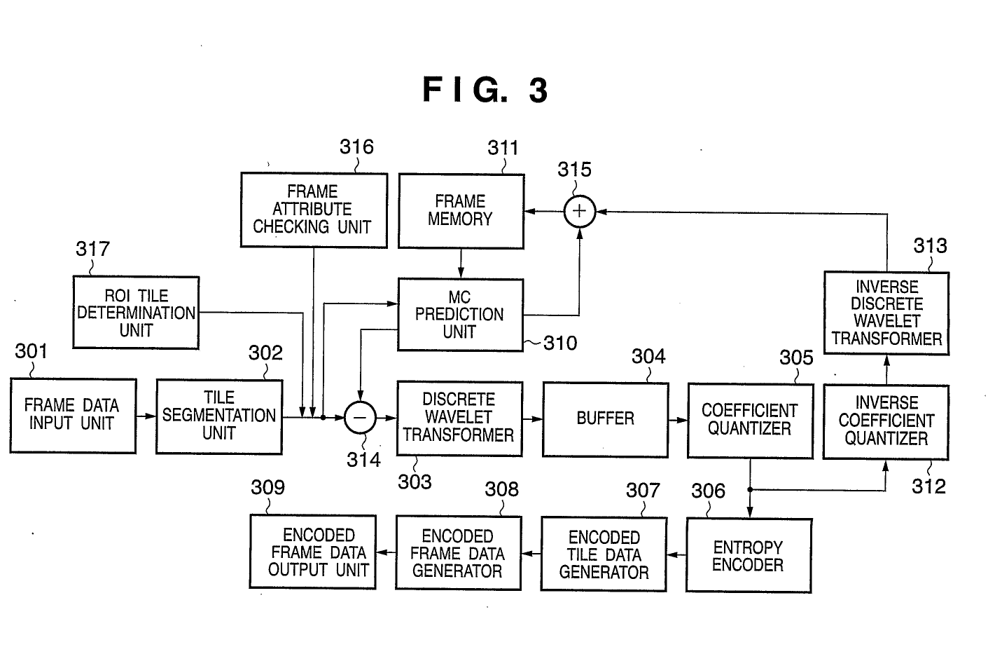

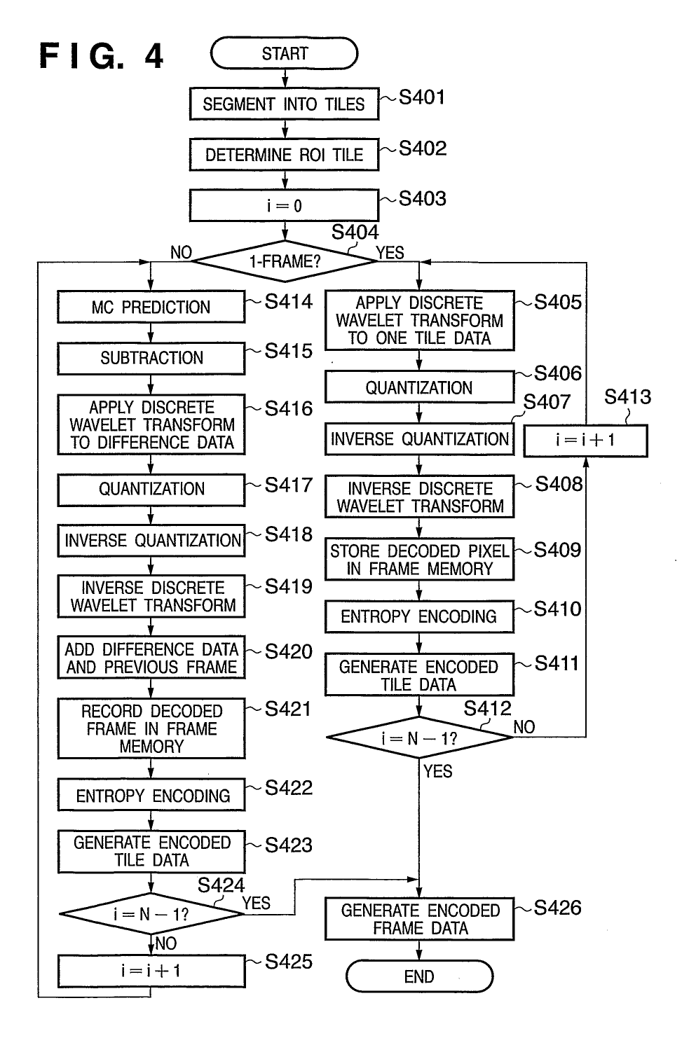

The frame data encoding process of the encoding unit 206 will be described below with reference to the block diagram showing the arrangement of the encoder 206 shown in FIG. 3 according to the first embodiment, and the flowchart of FIG. 4 showing the encoding process according to the first embodiment. Note that details such as a header generation method and the like are as described in the ISO/IEC recommendation, and a description thereof will be omitted.

In the following description, assume that frame data to be encoded is 8-bit monochrome frame data. However, the present invention is not limited to such specific frame data format. For example, the present invention can be applied to an image which is expressed by the number of bits other than 8 bits (e.g., 4 bits, 10 bits, or 12 bits per pixel). Further, the present invention can be applied to not only a monochrome image but also a color image (RGB/Lab/YCrCb). Also, the present invention can be applied to multi-valued information which represents the states and the like of each pixel that forms an image. An example of the multi-valued information is a multi-valued index value which represents the color of each pixel. In these applications, each kind of multi-valued information can be considered as monochrome frame data to be described later.

Pixel data which form each frame data of an image to be encoded are input from the image sensing unit 204 to a frame data input unit 301 in a raster scan order, and are then output to a tile segmentation unit 302.

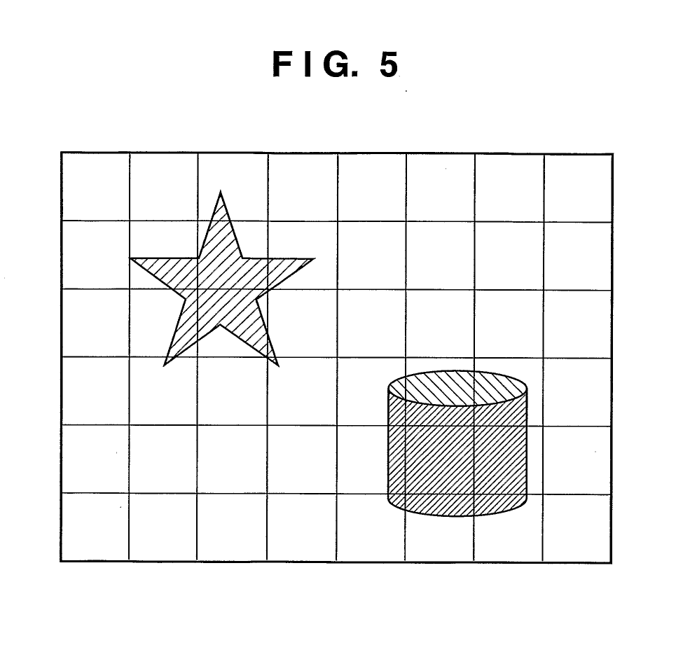

The tile segmentation unit 302 segments one image input from the frame data input unit 301 into N tiles, as shown in FIG. 5 (step S401), and assigns tile numbers 0, 1, 2, . . . , N-1 to the N tiles in a raster scan order in the first embodiment so as to identify respective tiles. Data that represents each tile will be referred to as “tile data” hereinafter. FIG. 5 shows an example in which an image is broken up into 48 tiles (=8 (horizontal)×6(vertical)), but the number of segmented tiles can be changed as needed. These generated tile data are sent in turn to a discrete wavelet transformer 303. In the processes of the discrete wavelet transformer 303 and subsequent units, encoding is done for each tile data.

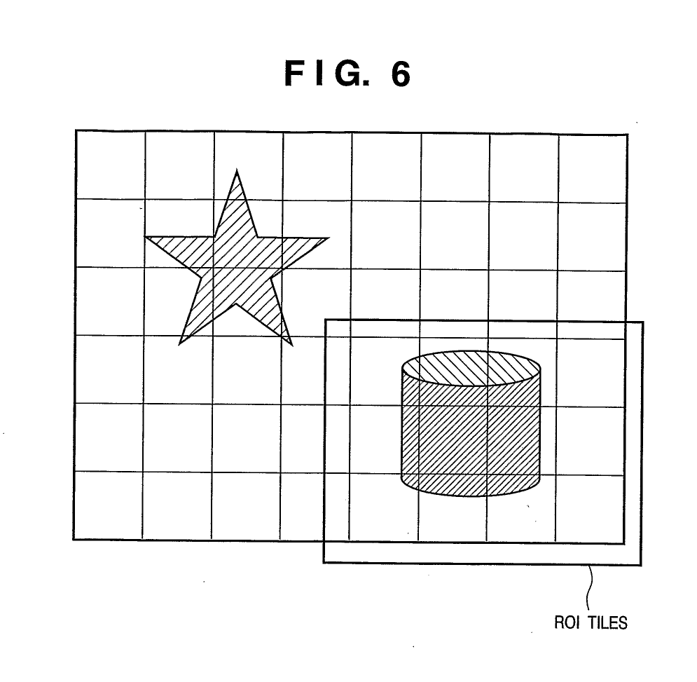

An ROI tile determination unit 317 determines a tile (ROI tile) or tiles of, e.g., an important area and an area of interest, to be encoded with higher image quality than other tiles (step S402). FIG. 6 shows an example of the determined ROI tiles. Note that the ROI tile determination unit 317 determines a region which includes a preferred region designated by an input device (not shown) by the user as an ROI tile or tiles. In step S403, a counter used to recognize a tile to be processed is set to i=0.

A frame attribute checking unit 316 checks if the frame to be encoded is an I-frame (Intra frame) or a P-frame (Predictive frame) (step S404). If the frame to be encoded is an I-frame, tile data are output to the discrete wavelet transformer 303 without being processed by a subtractor 314. On the other hand, if the frame to be encoded is a P-frame, frame data is copied to a motion compensation (MC) prediction unit 310.

### [When Frame to Be Encoded is I-Frame]

When the frame to be encoded is an I-frame, the discrete wavelet transformer 303 computes the discrete wavelet transform using data of a plurality of pixels (reference pixels) (to be referred to as “reference pixel data” hereinafter) in one tile data x(n) in frame data of one frame image, which is input from the tile segmentation unit 302 (step S405).

Note that frame data after undergone the discrete wavelet transform (discrete wavelet transformation coefficients) is given by:

Y(2n)=X(2n)+floor{(Y(2n−1)+Y(2n+1)+2)/4}

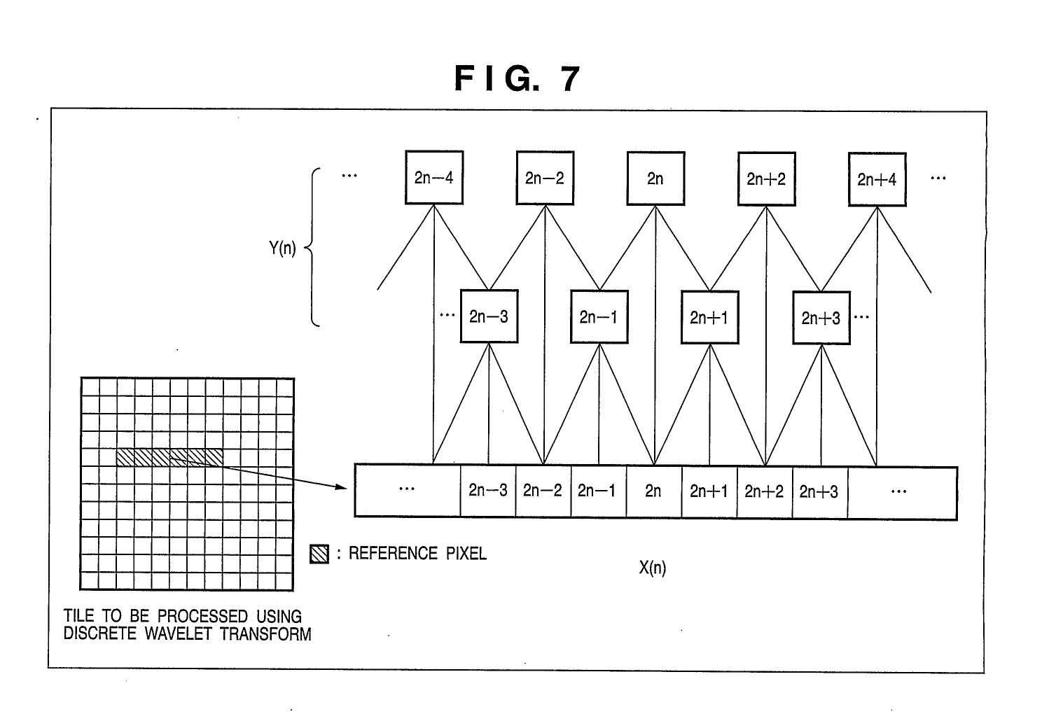

Y(2n+1)=X(2n+1)-floor{(X(2n)+X(2n+2))/2} (1)

where Y(2n) and Y(2n+1) are discrete wavelet transformation coefficient sequences; Y(2n) indicates a low-frequency subband, and Y(2n+1) indicates a high-frequency subband. Also, floor{X} in transformation formulas (1) indicates a maximum integer which does not exceed X. FIG. 7 illustrates this discrete wavelet transform process.

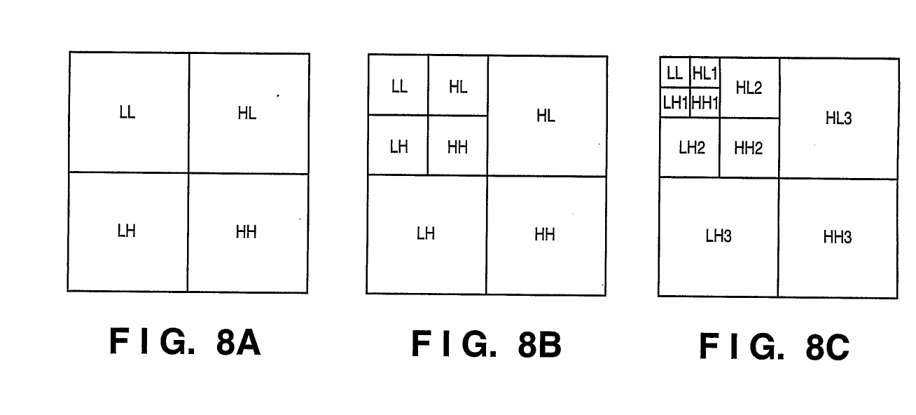

Transformation formulas (1) correspond to one-dimensional data. When two-dimensional transformation is attained by applying this transformation in turn in the horizontal and vertical directions, data can be broken up into four subbands LL, HL, LH, and HH, as shown in FIG. 8A. Note that L indicates a low-frequency subband, and H indicates a high-frequency subband, and the first letter of the combinations of L and H expresses the type of a subband in the horizontal direction, and the second letter of the combinations of L and H expresses the type of the subband in the vertical direction. Then, the LL subband is similarly broken up into four subbands (FIG. 8B), and an LL subband of these subbands is further broken up into four subbands (FIG. 8C). In this way, a total of 10 subbands are formed. The 10 subbands are respectively named HH1, HL1, . . . , as shown in FIG. 8C. A suffix in each subband name indicates the level of a subband. That is, the subbands of level 1 are HL1, HH1, and LH1, those of level 2 are HL2, HH2, and LH2, and those of level 3 are HL3, HH3, and LH3. Note that the LL subband is a subband of level 0. Since there is only one LL subband, no suffix is appended. A decoded image obtained by decoding subbands from level 0 to level n will be referred to as a decoded image of level n hereinafter. The decoded image has higher resolution with increasing level.

The transformation coefficients of the 10 subbands are temporarily stored in a buffer 304, and are output to a coefficient quantizer 305 in the order of LL, HL1, LH1, HH1, HL2, LH2, HH2, HL3, LH3, and HH3, i.e., in turn from a subband of lower level to that of higher level.

The coefficient quantizer 305 quantizes the transformation coefficients of the subbands output from the buffer 304 by quantization steps which are determined for respective frequency components (step S406), and outputs quantized values (quantized coefficient values) to an entropy encoder 306 and an inverse coefficient quantizer 312. Let X be a coefficient value, and q be a quantization step value corresponding to a frequency component to which this coefficient belongs. Then, quantized coefficient value Q(X) is given by:

Q(X)=floor{(X/q)+0.5} (2)

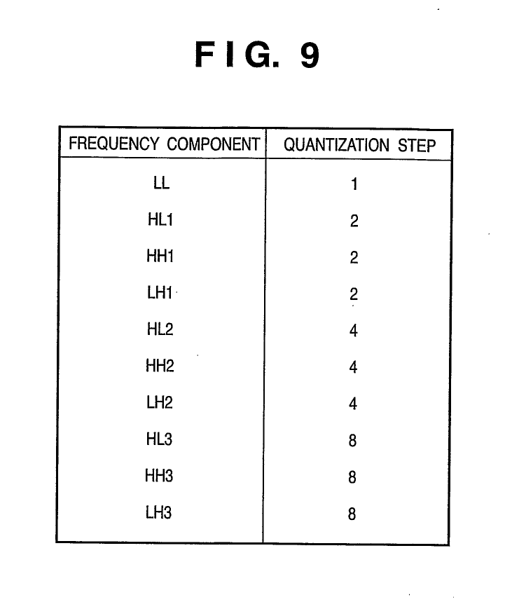

FIG. 9 shows the correspondence between frequency components and quantization steps in this embodiment. As shown in FIG. 9, a larger quantization step is given to a subband of higher level in this embodiment. Note that the quantization steps for respective subbands are stored in advance in a memory such as a RAM, ROM, or the like (not shown). After all transformation coefficients in one subband are quantized, these quantized coefficient values are output to the entropy encoder 306 and the inverse coefficient quantizer 312.

The inverse coefficient quantizer 312 inversely quantizes, using the quantization steps shown in FIG. 9, the quantized coefficient values (step S407) based on:

Y=q*Q (3)

where q is the quantization step, Q is the quantized coefficient value, and Y is the inverse quantized value.

An inverse discrete wavelet transformer 313 computes the inverse discrete wavelet transforms of the inverse quantized values (step S408) using:

X(2n)=Y(2n)-floor{(Y(2n−1)+Y(2n+1)+2)/4}

X(2n+1)=Y(2n+1)+floor{(X(2n)+X(2n+2)/2} (4)

The obtained decoded pixel is recorded in a frame memory 311 without being processed by an adder 315 (step S409).

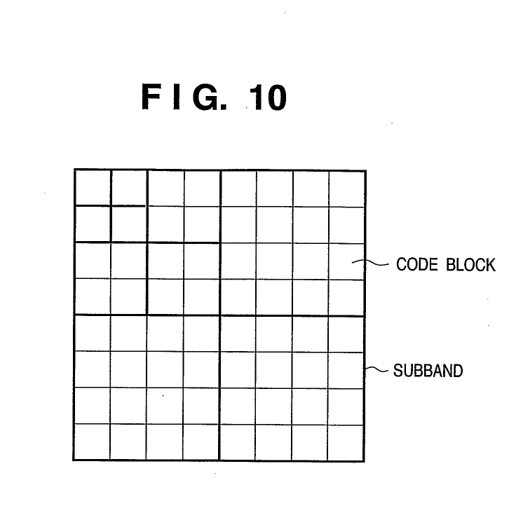

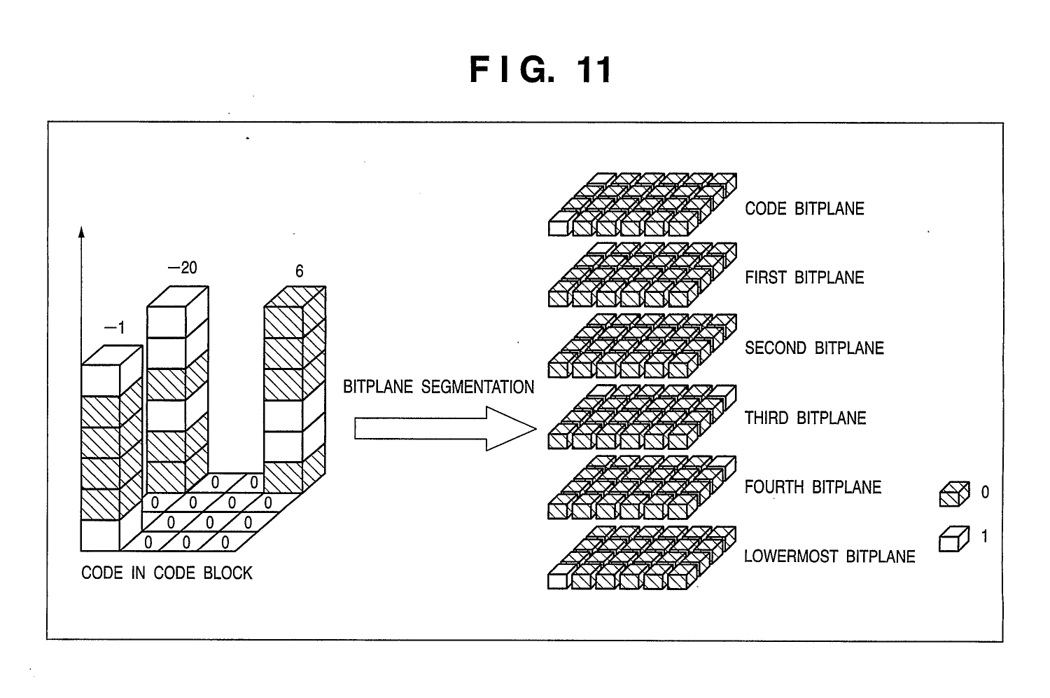

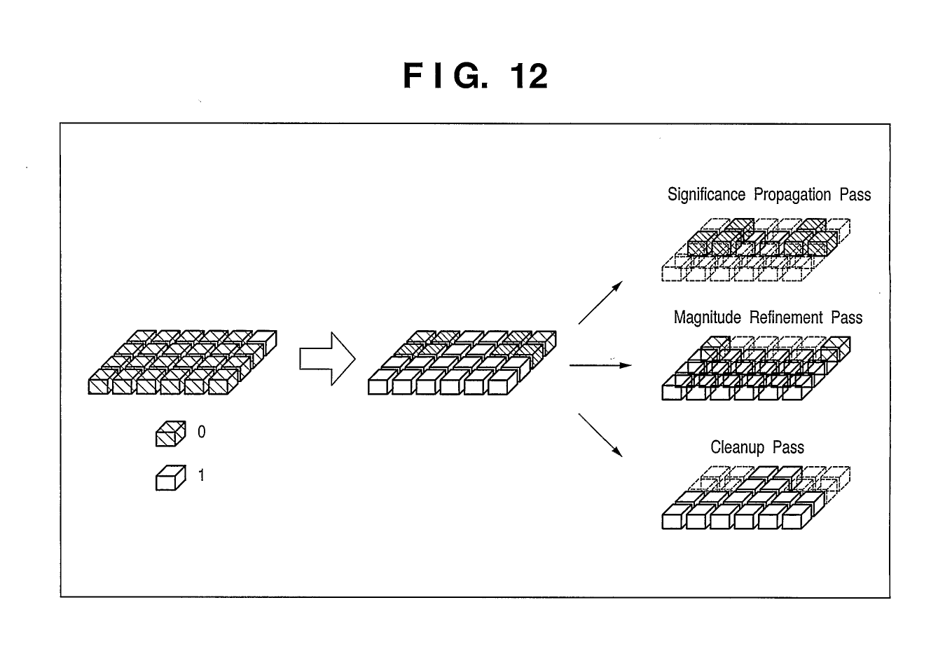

On the other hand, the entropy encoder 306 entropy-encodes the input quantized coefficient values (step S410). In this process, each subband as a set of input quantized coefficient values is segmented into rectangles (to be referred to as “code blocks” hereinafter), as shown in FIG. 10. Note that the code block is set to have a size of 2 m×2n (m and n are integers equal to or larger than 2) or the like. Furthermore, the code block is broken up into bitplanes, as shown in FIG. 11. Bits on the respective bitplanes are categorized into three groups on the basis of predetermined categorizing rules to generate three different coding passes as sets of bits of identical types, as shown in FIG. 12. The three different coding passes include a significance propagation pass as a coding pass of insignificant coefficients around which significant coefficients exist, a magnitude refinement pass as a coding pass of significant coefficients, and a cleanup pass as a coding pass of remaining coefficient information.

The input quantized coefficient values undergo binary arithmetic encoding as entropy encoding using the obtained coding passes as units, thereby generating entropy encoded values.

Note that entropy encoding of one code block is done in the order from upper to lower bitplanes, and a given bitplane of that code block is encoded in turn from the upper one of the three different passes shown in FIG. 12. Note that FIG. 12 shows the classification of the coding passes of the fourth bitplane shown in FIG. 11.

The entropy-encoded coding passes are output to an encoded tile data generator 307.

The encoded tile data generator 307 forms one or a plurality of layers based on the plurality of input coding passes, and generates encoded tile data using these layers as data units (step S411). The format of layers will be described below.

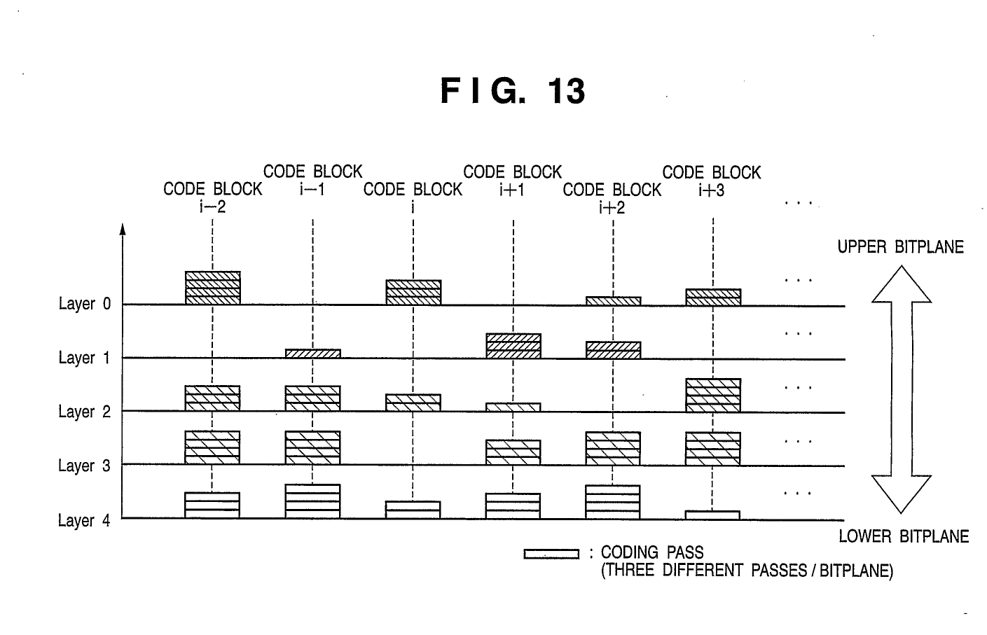

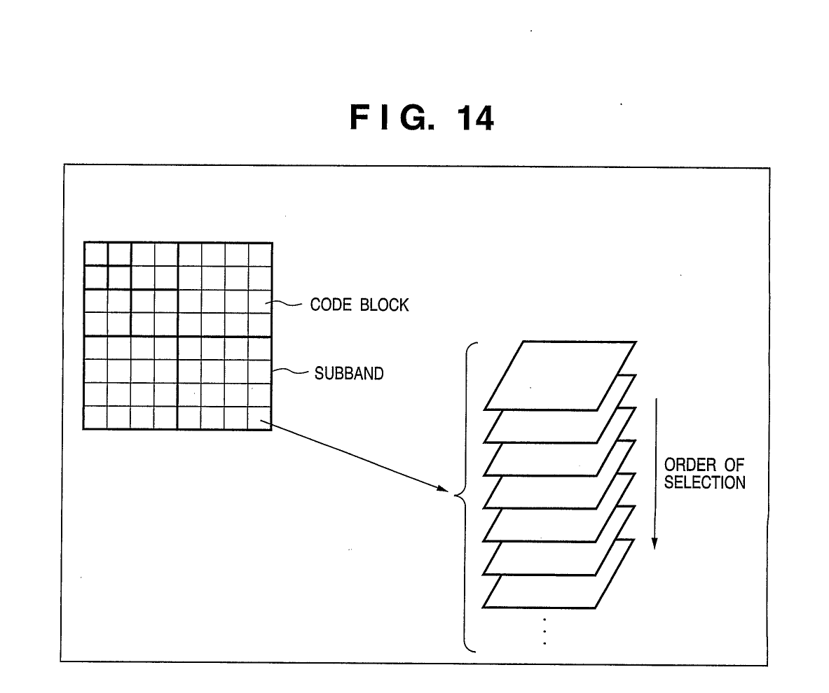

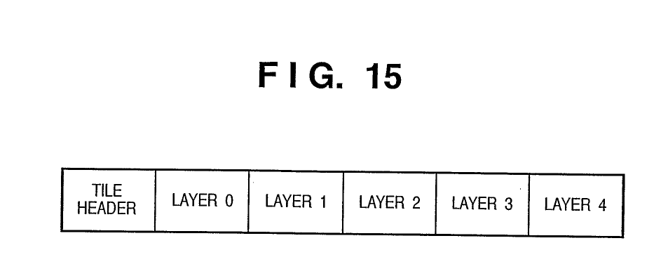

The encoded tile data generator 307 forms layers after it collects the entropy-encoded coding passes from the plurality of code blocks in the plurality of subbands, as shown in FIG. 13. FIG. 13 shows a case wherein five layers are to be generated. Upon acquiring coding passes from an arbitrary code block, coding passes are always selected in turn from the uppermost one in that code block, as shown in FIG. 14. After that, the encoded tile data generator 307 arranges the generated layers in turn from an upper one, and appends a tile header to the head of these layers, thus generating encoded tile data, as shown in FIG. 15. This header carries information used to identify a tile, the code length of the encoded tile data, various parameters used in compression, and the like. The encoded tile data generated in this way is output to an encoded frame data generator 308.

Whether or not tile data to be encoded still remain is determined in step S412 by comparing the value of counter i and the number of tiles. If tile data to be encoded still remain (i.e., i<N-1), counter i is incremented by 1 in step S413, and the flow returns to step S405 to repeat the processes up to step S412 for the next tile. If no tile data to be encoded remains (i.e., i=N-1), the flow advances to step S426.

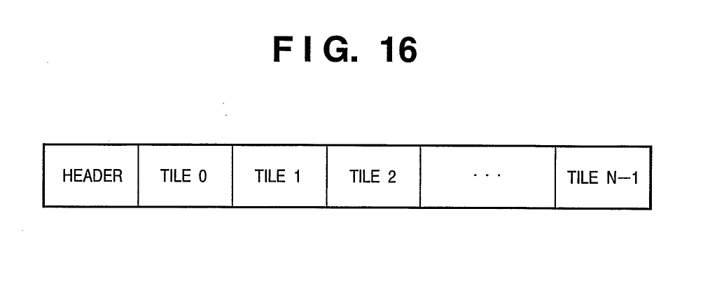

The encoded frame data generator 308 arranges the encoded tile data shown in FIG. 15 in a predetermined order (e.g., ascending order of tile number), as shown in FIG. 16, and appends a header to the head of these encoded tile data, thus generating encoded frame data (step S426). This header carries information such as the vertical×horizontal sizes of the input image and each tile, various parameters used in compression, and the like. The encoded frame data generated in this way is output from an encoded frame data output unit 309 to the storage unit 203 shown in FIG. 2.

In the above description, the processes in steps S407 to S409 are done prior to those in steps S410 and S411. However, these processes may be done in the reverse order or parallelly.

### [When Frame to be Encoded is P-Frame]

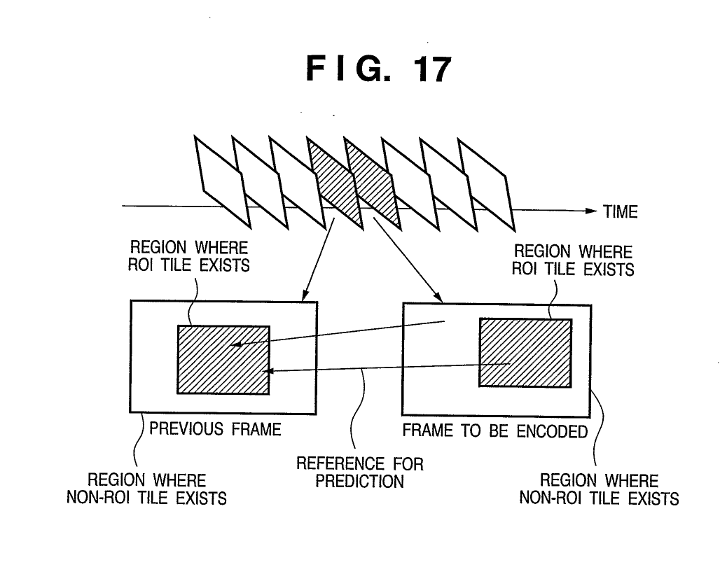

The processing to be executed when the frame to be encoded is a P-frame will be explained below. In this case, as described above, the tile segmentation unit 302 copies the frame data to the MC prediction unit 310, which performs MC prediction between the frame (previous frame) recorded in the frame memory 311 and the frame to be encoded (step S414). Note that the reference data for MC prediction is limited to the ROI tile or tiles of the previous frame, as shown in FIG. 17. This is to avoid the image quality drop of non-ROI tiles due to accumulation of discarded data in the encoded tile data generator.

A subtractor 314 calculates the difference between the previous frame and the frame to be encoded on the basis of the predicted result (step S415). The subtraction result (difference data) obtained by the subtractor 314 undergoes discrete wavelet transform (step S416), quantization (step S417), inverse quantization (step S418), inverse discrete wavelet transform (step S419), entropy encoding (step S422), encoded tile data generation (step S423), tile number check (step S424), and encoded frame data generation (step S426), in the same manner as in the processes for the I-frame.

Unlike in the I-frame processes, processes for calculating the sum of the difference data and previous frame by the adder 315 to reclaim the frame to be encoded (step S420), and recording the obtained decoded frame in the frame memory 311 (step S421) are added. In step S414 above, MC prediction is made using the decoded frame recorded in this process.

The processes in steps S414 to S423 are repeated via the process for incrementing counter i one by one in step S425, until it is determined in step S424 that no tile data to be encoded remains.

Note that a data unit used in prediction may adopt, inter alia, a tile, a block obtained by further segmenting a tile, and the like.

Further, an ROI tile or tiles of the previous frame is used as reference data for MC prediction in the above explanation, however, an ROI tile or tiles of any frame may be used as long as it can be used for MC prediction.

In the description of FIG. 4, the processes in steps S418 to S421 are executed prior to those in steps S422 and S423. However, these processes may be done in the reverse order or parallelly.

As described above, according to the first embodiment, since only the ROI tile or tiles of the previous frame is set as reference data for MC prediction, the image quality drop of P-frames due to accumulation of discarded data in the encoded tile data generator can be avoided.

### SECOND EMBODIMENT

The first embodiment has explained the method of avoiding image quality drop of P-frames due to accumulation of discarded data in the encoded tile data generator by limiting the reference data for prediction to the ROI tile or tiles.

In general, the user sets a given object as an ROI, and a tile or tiles including that object is determined as an ROI tile or tiles. For this reason, neighboring frames have similar pixel distributions and characteristics of ROI tiles. For this reason, prediction between neighboring ROI tiles can realize high encoding efficiency. However, prediction between ROI and non-ROI tiles cannot often realize high encoding efficiency. If high encoding efficiency cannot be realized, the MC prediction process is wasted. Hence, in the second embodiment, MC prediction is done between only ROI tiles. Note that the second embodiment is substantially the same as the first embodiment, except for the process in step S415 in the encoding processing shown in FIG. 4. Therefore, only a difference will be explained below.

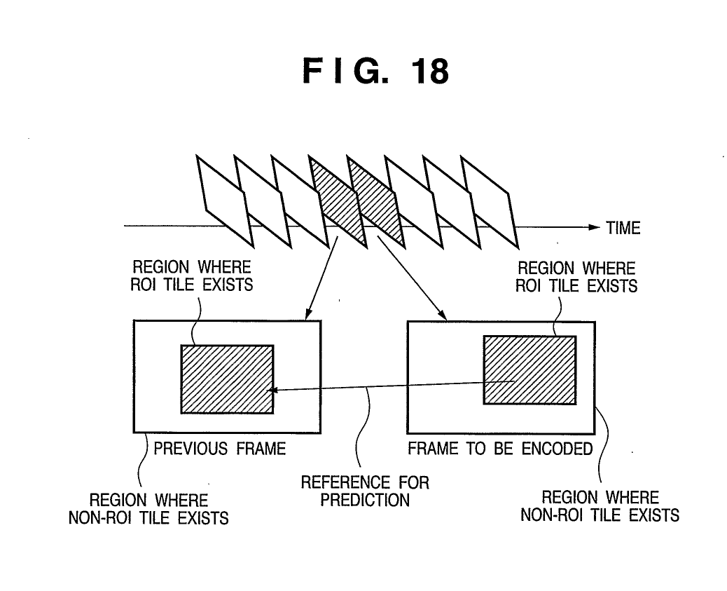

FIG. 18 shows the process of the MC prediction unit 310, which is executed in step S415 in the second embodiment. As shown in FIG. 18, MC prediction is executed between only ROI tiles, and that of non-ROI tiles is skipped.

As described above, according to the second embodiment, since MC prediction is executed between only ROI tiles, the image quality drop of P-frames can be avoided by skipping wasteful operations.

### THIRD EMBODIMENT

In the third embodiment, an ROI region is set on the discrete wavelet transformation coefficient space without setting an ROI region by tiles. By limiting reference data for prediction to ROI coefficients, the image quality drop of P-frames is avoided.

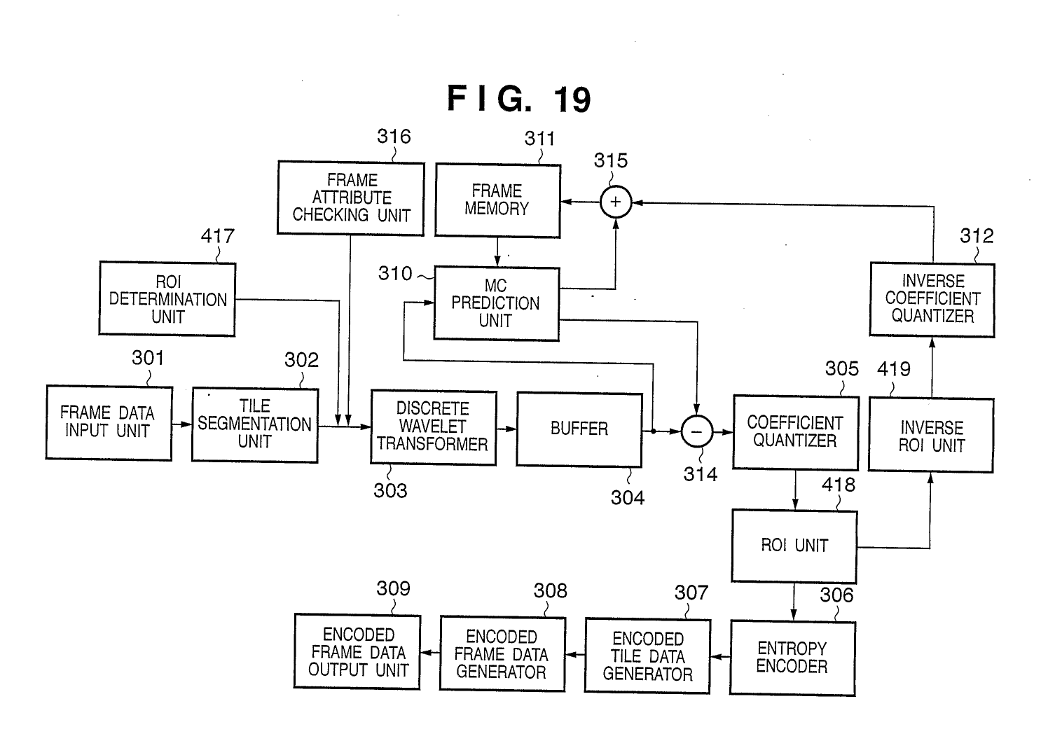

FIG. 19 is a block diagram of the encoding unit 206 according to the third embodiment. Assume that the moving image processing apparatus has the same arrangement as that shown in FIG. 2. In the arrangement shown in FIG. 19, the ROI tile determination unit 317 is replaced by an ROI determination unit 417 compared to the block diagram of the encoding unit 206 in the first embodiment. A difference lies in that the ROI tile determination unit 317 determines a region by tiles, but the ROI determination unit 417 determines a region by pixels. For example, the former ROI tile determination unit 317 determines a tile or tiles including a region extracted by an object extraction unit (not shown) as an ROI tile or tiles, while the latter ROI determination unit 417 determines an extracted region as an ROI region by pixels.

Also, differences are that the position of the subtractor 314 is changed since data which is to undergo prediction is changed from a pixel to a discrete wavelet transformation coefficient, an ROI unit 418 and inverse ROI unit 419 are added, and the need for the inverse discrete wavelet transformer 313 is obviated.

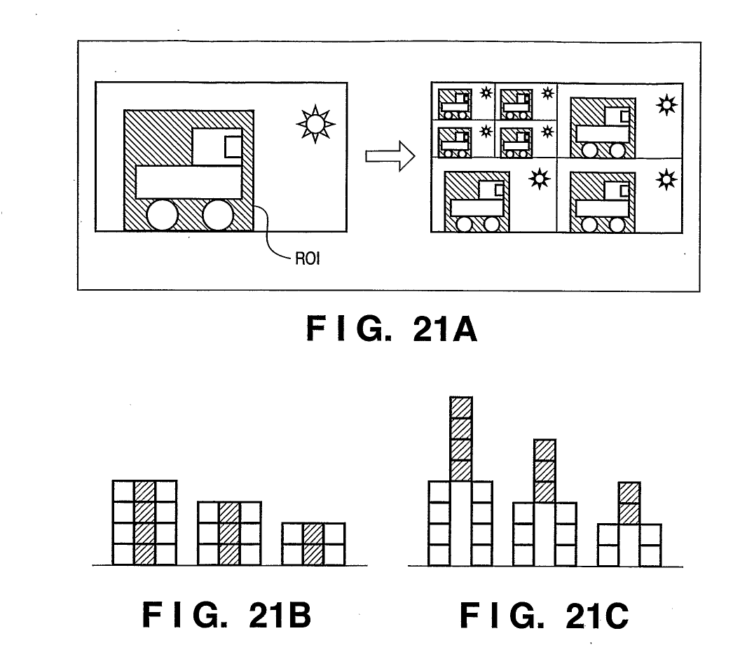

FIG. 21A shows an ROI and non-ROI in respective subbands, and FIGS. 21B and 21C are conceptual views showing changes in quantized coefficient values due to shift-up. Three quantized coefficient values exist for respective three subbands in FIG. 21B, and the hatched quantized coefficient values are those configuring an ROI. The values are changed as those shown in FIG. 21C after the shift-up process.

The inverse ROI unit 419 converts coefficients from FIG. 21C to FIG. 21B.

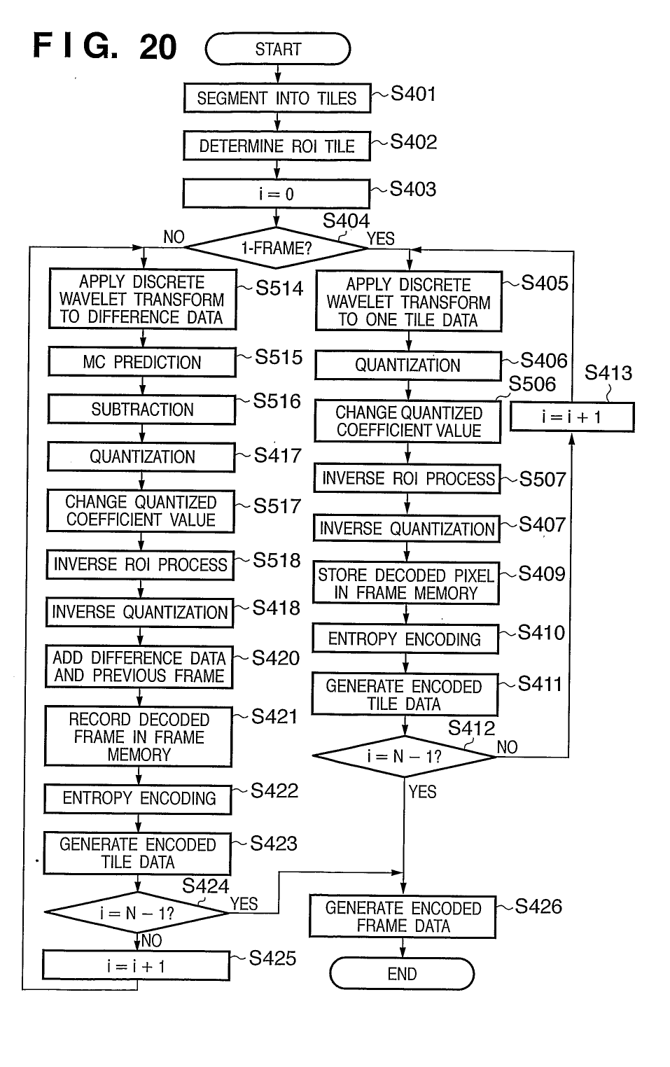

FIG. 20 is a flowchart showing the encoding process of the third embodiment. The same reference numbers denote the same processes as in the flowchart of FIG. 4, and a description thereof will be omitted.

### [When Frame to be Encoded is I-Frame]

In the third embodiment, when the frame to be encoded is an I-frame, after transformation coefficients computed by the discrete wavelet transformer 303 are quantized (step S406), the ROI unit 418 changes a quantized coefficient value (step S506) depending on whether or not the value is of ROI on the basis of:

Q″=Q*2^{B}; (Q: the absolute value of the quantized coefficient value obtained from a pixel in the ROI)

Q′=Q; (Q: the absolute value of the quantized coefficient value other than the above value). . . (5) where B is given for each subband. In a subband of interest, each Q′ is set to be larger than every Q″. A bit shift-up process is done so that bits which form a source quantized coefficient value of Q′ never exist at the same digit positions as those which form a source quantized coefficient value of Q″.

With the above process, only the quantized coefficient values associated with the ROI are shifted to higher bits by B bits.

The inverse ROI unit 419 executes a process for shifting down the ROI whose bits are shifted up by the ROI unit 418 (step S507).

### [When Frame to be Encoded is P-Frame]

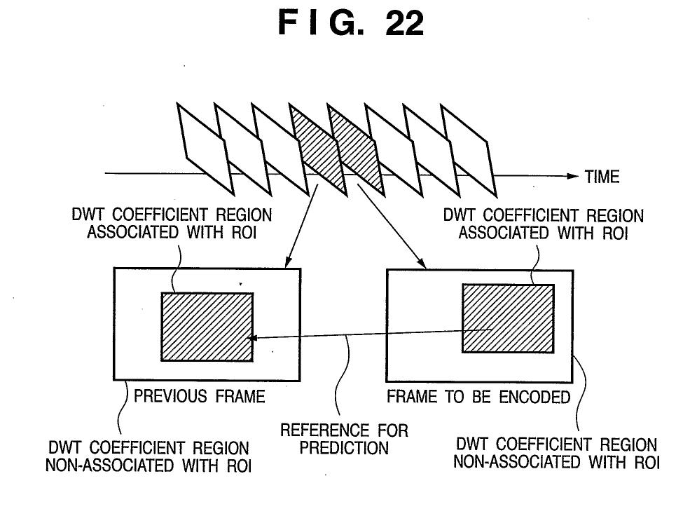

When the frame to be encoded is a P-frame, in the third embodiment, the discrete wavelet transformer 303 performs discrete wavelet transform (step S514). After that, MC prediction unit 310 performs MC prediction on the discrete wavelet transformation coefficient space (step S515). Note that the MC prediction unit 310 limits reference data for prediction to only DWT coefficients associated with ROI coefficients, as shown in FIG. 22.

The subtractor 314 calculates the difference (difference data) between the previous frame and the frame to be encoded on the basis of the predicted result (step S516). The coefficient quantizer 305 quantizes this difference data (step S417). After that, the ROI unit 418 changes the quantized coefficient values of the difference data depending on whether or not the value is of ROI using the formulas (5) above (step S517).

The inverse ROI unit 419 executes a process for shifting down the ROI whose bits are shifted up by the ROI unit 418 (step S518).

As described above, according to the third embodiment, MC prediction is executed using only coefficients associated with the ROI, thus avoiding the image quality drop of P-frames.

### OTHER EMBODIMENTS

In the first to third embodiments, the inventions have been explained using the discrete wavelet transform. Also, the scope of the present invention includes embodiments that adopt discrete cosine transformation.

The present invention may be applied to either a part of a system constituted by a plurality of devices (e.g., a host computer, interface device, reader, printer, and the like), or a part of an apparatus including a single equipment (e.g., a copying machine, digital camera, or the like).

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

In the claims:

1. A moving image encoding apparatus for encoding a moving image using inter-frame motion prediction, comprising:
a segmentation unit that segments each frame into a plurality of segmented regions;
a determination unit that determines a region of interest from a frame to be encoded;
an inter-frame prediction unit that retrieves a pixel set, from the region of interest of a previous or succeeding frame, having high correlation to each segmented region of a frame to be encoded, calculates a difference between the data of each segmented region and data of the retrieved pixel set, and outputs difference data; and
an encoding unit that encodes the difference data.

2. The apparatus according to claim 1, wherein said encoding unit preferentially discards data from a region other than the region of interest so as to adjust a code size.

3. The apparatus according to claim 1 further comprising a checking unit that checks if the frame to be encoded is a frame which is to undergo intra-frame encoding or a frame which is to undergo inter-frame encoding,
wherein, when said checking unit determines that the frame to be encoded is the frame which is to undergo intra-frame encoding, a process by said inter-frame prediction unit is skipped, and said encoding unit encodes data of each segmented region of the frame to be encoded.

4. The apparatus according to claim 1, wherein said inter-frame prediction unit executes a process for only the region of interest determined by said determination unit of the segmented regions of the frame to be encoded.

5. The apparatus according to claim 1, wherein said encoding unit performs discrete wavelet transform.

6. The apparatus according to claim 5, wherein said encoding unit performs encoding by a JPEG2000 encoding scheme.

7. The apparatus according to claim 1, wherein said encoding unit performs discrete cosine transformation.

8. A moving image encoding apparatus for encoding a moving image using inter-frame motion prediction, comprising:
a segmentation unit that segments each frame into a plurality of segmented regions;
a determination unit that determines a region of interest from a frame to be encoded;
a transformation unit that performs data transformation for each segmented region to generate transformation coefficients;
an inter-frame prediction unit that retrieves transformation coefficients, from transformation coefficients corresponding to the region of interest of a previous or succeeding frame, having high correlation to transformation coefficients of each segmented region of a frame to be encoded, calculates a difference between the transformation coefficients of each segmented region and the retrieved transformation coefficients, and outputs difference data; and
an encoding unit that encodes the difference data.

9. The apparatus according to claim 8, wherein said encoding unit preferentially discards data from a region other than the region of interest so as to adjust a code size.

10. The apparatus according to claim 8 further comprising a checking unit that checks if the frame to be encoded is a frame which is to undergo intra-frame encoding or a frame which is to undergo inter-frame encoding,
wherein, when said checking unit determines that the frame to be encoded is the frame which is to undergo intra-frame encoding, a process by said inter-frame prediction unit is skipped, and said encoding unit encodes transformation coefficients of each segmented region of the frame to be encoded.

11. The apparatus according to claim 8, wherein said inter-frame prediction unit executes a process for only transformation coefficients of the region of interest determined by said determination unit of the segmented regions of the frame to be encoded.

12. The apparatus according to claim 8, wherein said transformation unit performs discrete wavelet transform.

13. The apparatus according to claim 8, wherein said transformation unit performs discrete cosine transformation.

14. A moving image encoding method for encoding a moving image using inter-frame motion prediction, comprising:
segmenting each frame into a plurality of segmented regions;
determining a region of interest from a frame to be encoded;
retrieving a pixel set, from the region of interest of a previous or
succeeding frame, having high correlation to each segmented region of a frame to be encoded, calculating a difference between the data of each segmented region and data of the retrieved pixel set, and outputting difference data; and
encoding the difference data.

15. A moving image encoding method for encoding a moving image using inter-frame motion prediction, comprising:
segmenting each frame into a plurality of segmented regions;
determining a region of interest from a frame to be encoded;
performing data transformation for each segmented region to generate transformation coefficients;
retrieving transformation coefficients, from transformation coefficients corresponding to the region of interest of a previous or succeeding frame, having high correlation to transformation coefficients of each segmented region of a frame to be encoded, calculating a difference between the transformation coefficients of each segmented region and the retrieved transformation coefficients, and outputting difference data; and
encoding the difference data.

16. (canceled)

17. A storage medium readable by an information processing apparatus, characterized by storing a program for implementing a moving image encoding method of claim 14.

18. A storage medium readable by an information processing apparatus, characterized by storing a program for implementing a moving image encoding method of claim 15.
